(19) United States
(12) Patent Application Publication
(10) Pub. No.: US 2012/0150834 A1
(43) Pub. Date: Jun. 14, 2012

(54) CREATION SUPPORTING SYSTEM USING METADATA BASED ON USER AND INFORMATION PROVIDING METHOD THEREOF

(76) Inventors: Lee-Kwon CHOI, Seoul (KR); Woo-Joong Kim, Bucheon-si (KR); Sung-Jun Na, Seoul (KR); Seung-Kwon Lee, Seoul (KR); Sang-Beom Kim, Anyang-si (KR); Suk-Jin Yun, Seoul (KR); Dong-Soong Han, Jeonju-si (KR); Nam-Jin Kim, Cheonan-si (KR)

(21) Appl. No.: 13/316,665

(22) Filed: Dec. 12, 2011

(30) Foreign Application Priority Data
Dec. 14, 2010 (KR) 10-2010-0127425

(51) Int. Cl. G06F 17/30

(52) U.S. Cl. 707/706; 707/740; 707/E17.108; 707/E17.028

(57) ABSTRACT

Provided is a creation supporting system and method using user-based metadata. According to the creation supporting system and method, metadata collected by a user for video content are stored so as to be provided to a creator. The creation supporting system includes a user terminal configured to receive evaluation data on video content from a user who watched the video content; a utilizer terminal configured to receive a search value from a utilizer desiring a search and request a video content search; and a service providing server configured to receive the evaluation data from the user terminal, construct metadata of video content, and compare the search value received from the utilizer server with the metadata for searching for a corresponding video content.

### CROSS-REFERENCE TO RELATED APPLICATIONS

This U.S. non-provisional patent application claims priority under 35 U.S.C. §119 of Korean Patent Application No. 10-2010-0127425, filed on, Dec. 14, 2010, the entire contents of which are hereby incorporated by reference.

### BACKGROUND OF THE INVENTION

The present invention relates to a creation supporting system and method using user-based metadata, and more particularly, to a creation supporting system and method in which metadata collected by a user for video content are stored so as to be provided to a creator. The present invention has been derived as a result of conducting the project of ‘development of a creation supporting system for more interesting content’ organized by the Korea Creative Content Agency.

With recent developments of mass media, the type and quantity of content are explosively increased, and accordingly, users have more various demands related to content.

As a technology of a medium storage device is developed, content data not only simply store content but also include various types of information on the content to meet the above-mentioned various demands.

Users want to easily find content that they need. For satisfying this requirement, various technologies are developed, as disclosed in Korean Patent Application Publication Nos. 2004-0108726 and 2009-0070945.

According to the disclosed prior art, for easily searching video content for a scene wanted by a user, a content producer stores data related to the video (metadata) into each scene of the video content, and when the user inputs search data, the stored data are compared with the inputted data to search for partial video data wanted by the user and provide the found data to the user (see FIG. 1).

However, according to the prior art, the metadata, which are generated and stored by the content producer when the video data are generated, include only objective fact information on each scene.

Therefore, according to the prior art, the metadata are provided by the content producer, and general users use the metadata to search for video content.

However, in the case that the user of the video data and the producer of the video content are the same, i.e., in the case that a movie producer searches a movie, configurations different from the above description are required.

Movie producers have more need of general audiences' feelings about each scene than of objective information provided by movie producers. This is for understanding how audiences feel about the same scene, and for reflecting the reactions of the audiences for producing new content.

However, as described above, according to the prior art, it is limited to include the reactions of general audiences in video content.

### SUMMARY OF THE INVENTION

The present invention provides a creation supporting system and method for generating video content including metadata determined by inputs from users and for providing the video content to a content producer (creator)

The present invention also provides a creation supporting system and method for receiving an analysis reference from a content producer and producing an analysis result by varying an analysis method according to intention of the content producer.

Embodiments of the present invention provide systems for supporting creation by using user-based metadata, the systems including a user terminal configured to receive evaluation data on video content from a user who watched the video content; a utilizer terminal configured to receive a search value from a utilizer desiring a search and request a video content search; and a service providing server configured to receive the evaluation data from the user terminal, construct metadata of the evaluation data, and compare the search value received from the utilizer server with the metadata for searching for a corresponding video content, wherein the metadata include: basic information including content basic information storing objective information on overall video content and sector basic information storing subjective information on a particular scene; and evaluation information including content evaluation information storing user evaluations on overall video content and sector evaluation information storing user evaluations on a particular scene, wherein the search value includes: a basic search value for the objective information on the video content; and an evaluation search value for searching for subjective evaluations on the video content, wherein the service providing server includes: a database configured to store multiple pieces of video content including the metadata; and a search engine configured to compare the search value received from the utilizer server with the metadata stored in the database for searching for video content and a scene corresponding thereto, wherein the search engine produces an analysis result according to the basic search value.

In other embodiments of the present invention, systems for supporting creation by using user-based metadata include a user terminal configured to receive evaluation data on video content from a user who watched the video content; a utilizer terminal configured to receive a search value from a utilizer desiring a search and request a video content search; and a service providing server configured to receive the evaluation data from the user terminal, construct metadata of the evaluation data, and compare the search value received from the utilizer server with the metadata for searching for a corresponding video content, wherein the metadata include: basic information including content basic information storing objective information on overall video content and sector basic information storing subjective information on a particular scene; and evaluation information including content evaluation information storing user evaluations on overall video content and sector evaluation information storing user evaluations on a particular scene, wherein the search value includes: a basic search value for the objective information on the video content; an evaluation search value for searching for subjective evaluations on the video content; and an analysis reference value as a criterion for statistical analysis on a search result, wherein the service providing server includes: a database configured to store multiple pieces of video content including the metadata; and a search engine configured to compare the search value received from the utilizer server with the metadata stored in the database for searching for video content and a scene corresponding thereto, wherein the search engine produces an analysis result according to the analysis reference value inputted by the utilizer.

In still other embodiments of the present invention, information providing methods of a creation supporting system using user-based metadata include the steps of (A) receiving a search reference item from a service providing server through a utilizer terminal; (B) receiving a search value from a utilizer through the utilizer terminal and transferring the search value to the service providing server; (C) classifying the search value into a basic search value and an evaluation search value, comparing the basic search value with content basic information and sector basic information of metadata, and comparing the evaluation search value with content evaluation information and sector evaluation information of the metadata for searching for corresponding video content and a corresponding scene by using the service providing server; (D) producing an analysis result by arranging search results according to the basic search value; and (E) transferring the analysis result to the utilizer terminal, wherein, in the step (D), sectors corresponding to the evaluation information of particular content are arranged in time series of the particular content to thereby produce the analysis result in the case that the basic search value indicates the particular content; and cumulative frequencies of sectors corresponding to the evaluation information of each content belonging to a particular genre are arranged in time series of the each content to thereby produce the analysis result in the case that the basic search value indicates the particular genre.

In even other embodiments of the present invention, information providing methods of a creation supporting system using user-based metadata include the steps of (a) receiving a search reference item from a service providing server through a utilizer terminal; (b) receiving a search value from a utilizer through the utilizer terminal and transferring the search value to the service providing server; (c) classifying the search value into a basic search value and an evaluation search value, comparing the basic search value with content basic information and sector basic information of metadata, and comparing the evaluation search value with content evaluation information and sector evaluation information of the metadata for searching for corresponding video content and a corresponding scene by using the service providing server; (d) producing an analysis result by arranging search results according to an analysis reference value included in the search value; and (e) transferring the analysis result to the utilizer terminal, wherein, the search value includes: a basic search value for the objective information on the video content; an evaluation search value for searching for subjective evaluations on the video content; and an analysis reference value as a criterion for statistical analysis on a search result.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a diagram illustrating a media scene search system according to the related art;

FIG. 2 is a block diagram illustrating a content creation supporting system according to an embodiment of the present invention;

FIG. 3 is an exemplary diagram illustrating a structure of video content data according to the present invention;

FIG. 4 is a flowchart illustrating an exemplary process of generating metadata according to an information providing method of the creation supporting system;

FIG. 5 is a flowchart illustrating an exemplary process of searching content according to the information providing method of the creation supporting system;

FIG. 6 is a diagram illustrating an exemplary analysis result in the case that a basic search value is particular video content, according to the information providing method of the creation supporting system;

FIG. 7 is a diagram illustrating an exemplary analysis result in the case that the basic search value is a particular genre, according to the information providing method of the creation supporting system; and

FIG. 8 is a diagram illustrating an exemplary analysis result in the case that the basic search value is a plurality of genres, according to the information providing method of the creation supporting system.

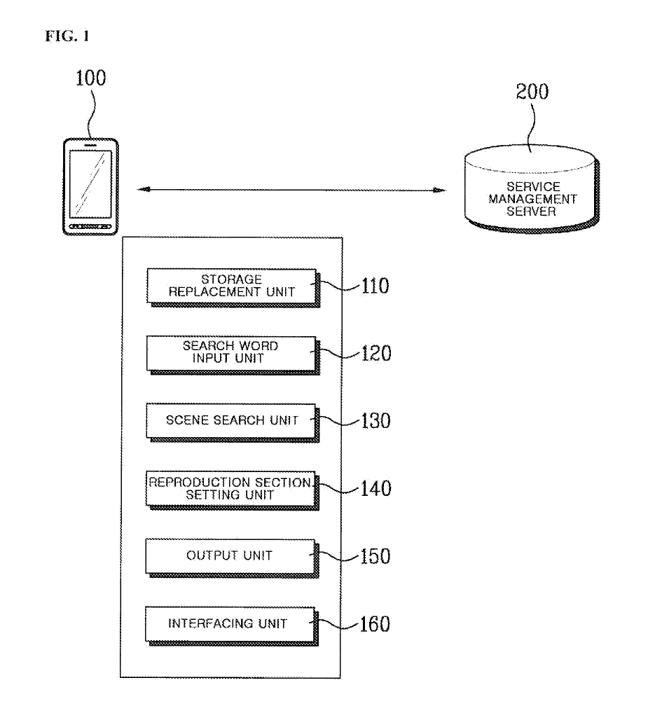

### DETAILED DESCRIPTION OF PREFERRED EMBODIMENTS

Hereinafter, preferred embodiments of the present invention will be described in detail with reference to the accompanying drawings.

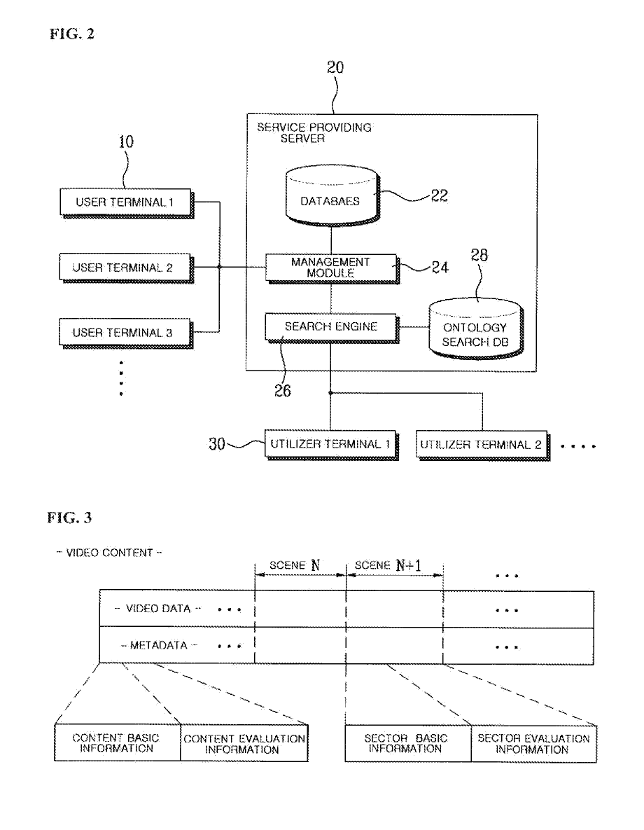

FIG. 2 is a block diagram illustrating a video content creation supporting system according to an embodiment of the present invention, and FIG. 3 is an exemplary diagram illustrating a structure of video content data according to the present invention.

As illustrated in FIGS. 2 and 3, the video content creation supporting system according to the present invention includes a plurality of user terminals (10), a service providing server 20, and utilizer terminals 30.

Hereinafter, the term “user” indicates a general audience (including not only an ordinary person such as a movie critic but also a person inputting evaluation on video content) who watched video content, and the term “utilizer” indicates a video content producer utilizing the creation supporting system according to the present invention (all persons who search video content through the creation supporting system are included in the utilizer.)

The user terminal 10 denotes a computer, mobile equipment, or the like used by an audience for inputting evaluation data of corresponding video content. The utilizer terminal 30 is typically used by a video producer to search video content by using the video content creation supporting system.

Meanwhile, the service providing server 20 provides an evaluation item to the user terminals 10 and receives the evaluation data from the users to construct metadata and provide the metadata to the utilizer terminals 30. To this end, the service providing server 20 includes a database 22, a management module 24, and a search engine 26.

The database 22 stores various pieces of video content to be searched. The video content includes basic video data including images/sounds/subtitles, and metadata (see FIG. 3).

The metadata store supplementary data related to the video content, and may be configured as various forms according to a file compression method.

Meanwhile, as illustrated in FIG. 3, the metadata include basic information and evaluation information. Herein, the basis information indicates objective information on the video content, and includes title/genre/actors of the video content.

Meanwhile, the basic information is divided into content basic information and sector basic information. The content basic information denotes overall information on the whole video content, and the sector basic information denotes objective information on a corresponding scene (e.g., an actor appearing in the corresponding scene).

Meanwhile, the evaluation information is constructed with evaluation result data inputted by the users, and includes subjective judgment of audiences.

Herein, the evaluation information is divided into content evaluation information and sector evaluation information. The content evaluation information indicates a portion in which overall evaluation on the whole video content, such as ‘movie title grabbing attention and interest’ and ‘story dealing with social problems’, is stored.

On the contrary, the sector evaluation information indicates a portion in which subjective evaluation on a corresponding scene, such as ‘best directed scene in corresponding content’, ‘most memorable speech’, and ‘unique accent and tone’, is stored.

Meanwhile, the management module 24 provides the evaluation item to the user terminals 10 and receives the evaluation data from the users to generate/update the metadata of the video content stored in the database 22.

Herein, the management module 24 classifies the users of the user terminals 10 into groups and respectively adds weights to the groups to adjust a reflection ratio of the metadata.

The groupage is performed according to login information of the users and the evaluation data inputted by the users. That is, the users are classified into multiple groups according to their tendencies determined on the basis of the above mentioned data.

Types of the groups may be, e.g., ‘topic-centric story pursuance type’/‘unexpected story pursuance type’/‘comic episode pursuance type’/‘comic character pursuance type’.

The management module 24 may adjust the reflection ratio of the metadata by adding weights to the evaluation data of the users according to the user groups. For instance, in the case that the user belongs to the ‘comic episode pursuance type’ and the evaluation data are for a comic episode genre, a high weight may be applied. On the contrary, in the case of video content belonging to a low-related genre, a low weight may be applied.

Meanwhile, the search engine 26 receives search data from the user terminal 30 and compares the search data with the metadata stored in the database 22 to provide corresponding video content and a corresponding scene thereof to the user terminal 30.

Herein, in order to easily match the search data inputted by the user with the evaluation information stored in the metadata, the search data may be changed to the same term as the evaluation information through an ontology comparison search.

To this end, the service providing server 20 may include an ontology search DB 28.

Meanwhile, the search engine 26 differently analyzes the search result according to a basic search value inputted by the user. For instance, in the case that the basic search value is particular video content, data corresponding to an evaluation search value included in a single particular piece of video content may be arranged in time series to thereby output an analysis result. In the case that the basic search value is a particular genre, each piece of video content belonging to the corresponding genre may be analyzed by arranging the evaluation search values included in the pieces of video content in time series. A method for outputting the analysis result according to the basic search value will be described in detail with a description of an information providing method according to the present invention.

Hereinafter, a video content creation supporting method according to an embodiment of the present invention will be described in detail.

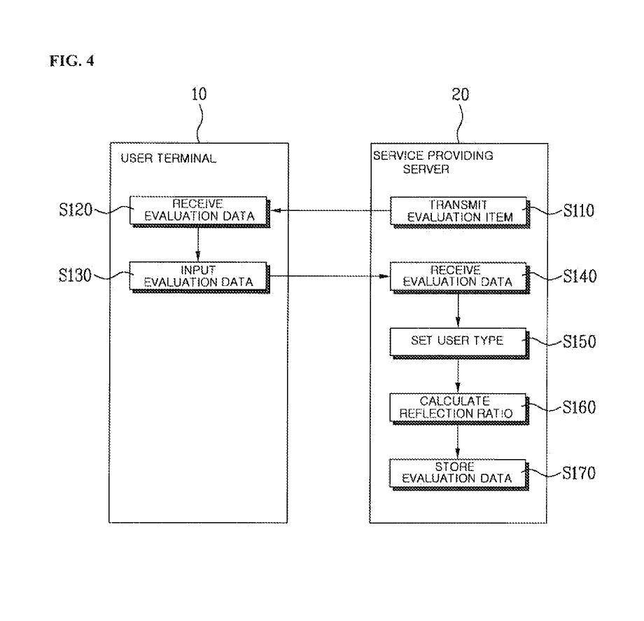

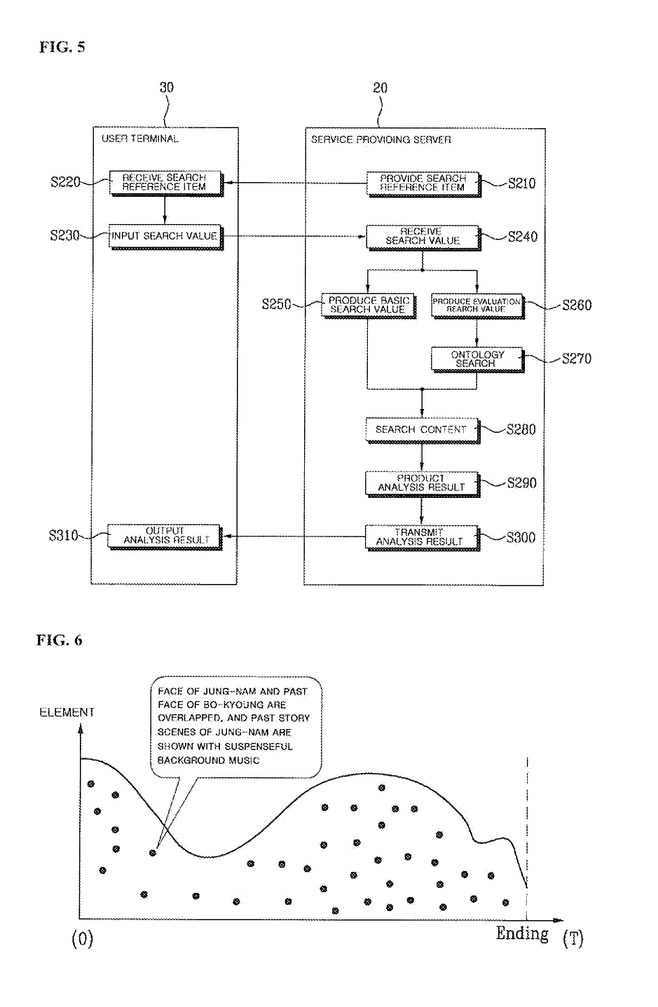

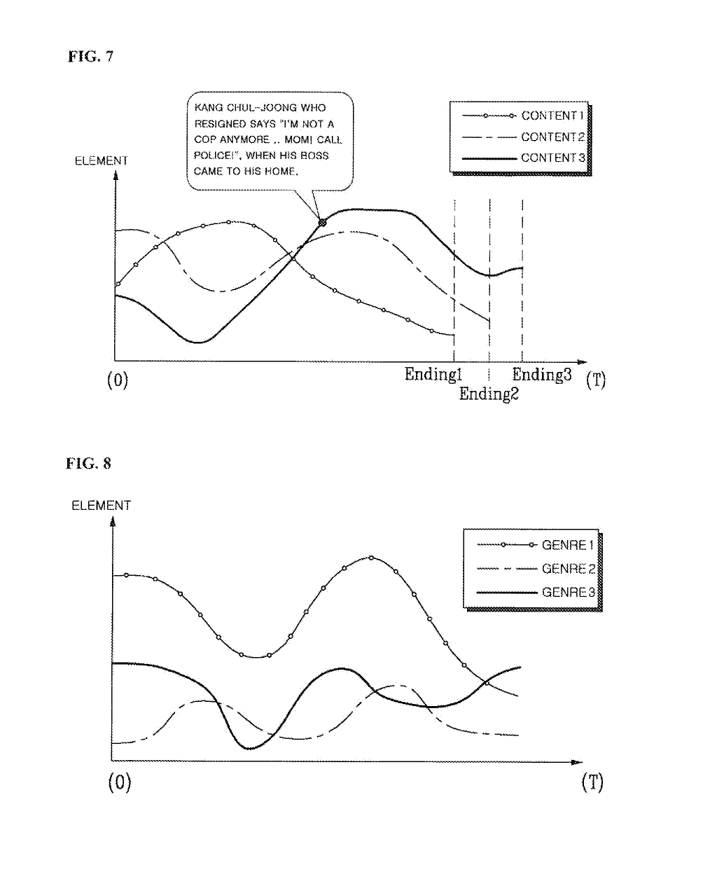

FIG. 4 is a flowchart illustrating an exemplary process of generating the metadata according to the information providing method of the creation supporting system, FIG. 5 is a flowchart illustrating an exemplary process of searching content according to the information providing method of the creation supporting system, FIG. 6 is a diagram illustrating an exemplary analysis result in the case that the basic search value is particular video content, according to the information providing method of the creation supporting system, FIG. 7 is a diagram illustrating an exemplary analysis result in the case that the basic search value is a particular genre, according to the information providing method of the creation supporting system, and FIG. 8 is a diagram illustrating an exemplary analysis result in the case that the basic search value is a plurality of genres, according to the information providing method of the creation supporting system.

Firstly, during the metadata generating process according to the present invention, as illustrated in FIG. 4, the evaluation item is transmitted to the user terminal 10 connected to the service providing server 20 in operation S110. Herein, the evaluation item includes a content evaluation item for video content and a sector evaluation item for a particular scene.

Thereafter, the user terminal 10 which received the evaluation item receives the evaluation data from the user and transmits the received data to the service providing server 20 in operations S120 and S130.

The service providing server 20 which received the evaluation data sets a user type by using the received evaluation data and the login information of the connected user terminal 10 in operations S130 and S140.

Thereafter, the service providing server 20 calculates the reflection ratio of the evaluation data according to the user type in operation S160. As described above, the reflection ratio is differently calculated according to how exactly the user type match with the type of video content to be evaluated.

Meanwhile, if the reflection ratio is calculated, metadata of the corresponding video content stored in the database 22 are stored/updated or modified by applying the reflection ratio to the evaluation data to thereby generate the metadata in operation S170.

Hereinafter, an embodiment of the method for performing the content analysis by using the utilizer terminal 30 will be described.

Firstly, as illustrated in FIG. 5, in order for the utilizer to search for desired content information through the utilizer terminal 30, the utilizer terminal 30 receives a search reference item from the service providing server 20 in operations S210 and S220.

Herein, it is preferable to select an item corresponding to the evaluation item as the search reference item. However, it is not necessary that both of them are matched with each other. This is because a search value may be matched with a stored value of the metadata through the ontology search described below even though the search reference item is not matched with the evaluation item, though search fixation is easily performed in the case that both of the items are matched with each other.

Further, similarly to the evaluation item, the search reference item includes a basic search value for objective information on video content and an evaluation search value for searching for subjective evaluations from the users.

Meanwhile, the utilizer terminal 30 which received the search reference item receives a search value from the utilizer and transmits the received search value to the service providing server 20 in operation 5230.

Then, the service providing server 20 which received the search value in operation S240 classifies it into the basic search value and the evaluation search value in operations S250 and S260.

Further, the evaluation search value is converted so as to be matched with the evaluation item by using an ontology synonym search in operation S270.

Thereafter, the search engine 26 compares the basic search value with the content basic information and sector basic information of the metadata to select content to be analyzed, and compares the evaluation search value converted by the ontology synonym search with the evaluation information included in the metadata to search corresponding content and a corresponding sector thereof in operation 5280.

Then, the search engine 26 arranges the found video data according to the basic search value to output an analysis result in operation 5290.

Thereafter, the analysis result is transmitted to the utilizer terminal 30, and the utilizer terminal 30 which received the analysis result outputs and provides a final result to the utilizer in operations S300 and S310.

Hereinafter, with reference to FIGS. 6 to 8, the method for producing the analysis result according to the basic search value will be described in detail.

The producing of the analysis result is to arrange the search result obtained in operation S280 according to intention of the utilizer so that the utilizer easily recognizes the search result.

For instance, the utilizer may intend to acquire information on a particular evaluation item for particular video content by using the creation supporting system according to the present invention. More specifically, for instance, it may be assumed that the utilizer intends to acquire information on a ‘fun element’ of the video content ‘Scandal Makers’.

In this case, the utilizer inputs the ‘Scandal Makers’ content as the basic search value, and inputs ‘fun element’ as the evaluation search value. As a matter of course, even though the utilizer inputs ‘laughing element’, ‘comic element’, or the like as the evaluation search value, this term is converted into ‘fun element’ through the ontology synonym conversion.

In this case, as illustrated in FIG. 6, the distribution of fun elements during the running time of video content is produced as the analysis result. Herein, for convenience of the utilizer, when the utilizer selects a corresponding fun element, an explanation on the corresponding fun element is additionally provided (see speech bubble in FIG. 6).

Meanwhile, the utilizer may intend to acquire information on a particular evaluation item from multiple pieces of video content belonging to a particular genre. More specifically, for instance, it may be assumed that the utilizer intends to acquire information on a ‘fun element’ of multiple pieces of video content belonging to a ‘comedy’ genre.

In this case, the utilizer inputs the ‘comedy’ genre as the basic search value, and inputs ‘fun element’ as the evaluation search value.

In this case, as illustrated in FIG. 7, each distribution of the fun elements of each piece of the video content belonging to the ‘comedy genre’ during each running time is produced as the analysis result.

Also in this case, for convenience of the utilizer, when the utilizer selects a particular time of particular video content, an explanation on the corresponding fun element may be additionally provided (see speech bubble in FIG. 7).

On the basis of this analysis result, the utilizer may understand the distribution of each evaluation element of various pieces of video content at a glance. Further, the utilizer may conduct a statistical analysis on distributions of each element (fun element, tense element, and the like) in commercially successful movies and not successful movies in order to find out the case of distribution which induces good responses of audiences.

In another case, the utilizer may intend to acquire information on a particular evaluation item from multiple pieces of video content belonging to all genres. More specifically, for instance, it may be assumed that the utilizer intends to acquire information on a ‘fun element’ of various pieces of video content belonging to ‘all’ genres or to ‘domestic movie’.

In this case, the utilizer inputs ‘all video content’ or ‘domestic video content’ as the basic search value, and inputs ‘fun element’ as the evaluation search value.

In this case, as illustrated in FIG. 8, the average distributions of fun elements for each genre of the ‘all (domestic)’ movies are produced as the analysis result.

In this case, this analysis result helps the utilizer understand the distribution of a particular element, e.g., the distribution of fun elements in a comedy, action, or drama movie.

In the above described embodiment, the basic search value inputted by the utilizer is used for obtaining the analysis result.

However, for producing more various analysis results, it may be possible to receive an analysis reference value from the utilizer.

That is, an item of the analysis reference value which is a reference for producing the analysis result is added to the search reference item so as to produce the analysis result on the basis of the analysis result production reference received from the utilizer.

For instance, in the case that the analysis reference value is ‘analysis for each nation’, the analysis result may be generated for each nation. In the case that the analysis reference value is ‘evaluation level’, the analysis result may be generated according to a level (determined according to ratings from the users and the number of the evaluators) of the fun element found in the search result. Further, the analysis reference value may be more diversified so that the analysis result may be generated according to various references.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A system for supporting creation by using user-based metadata, the system comprising:
a user terminal configured to receive evaluation data on video content from a user who watched the video content;
a utilizer terminal configured to receive a search value from a utilizer desiring a search and request a video content search; and
a service providing server configured to receive the evaluation data from the user terminal, construct metadata of video content, and compare the search value received from the utilizer server with the metadata for searching for a corresponding video content,
wherein the metadata comprise:
basic information comprising content basic information storing objective information on overall video content and sector basic information storing subjective information on a particular scene; and
evaluation information comprising content evaluation information storing user evaluations on overall video content and sector evaluation information storing user evaluations on a particular scene,
wherein the search value comprises:
a basic search value for the objective information on the video content; and
an evaluation search value for searching for subjective evaluations on the video content,
wherein the service providing server comprises:
a database configured to store multiple pieces of video content comprising the metadata; and
a search engine configured to compare the search value received from the utilizer server with the metadata stored in the database for searching for video content and a scene corresponding thereto,
wherein the search engine produces an analysis result according to the basic search value.

2. A system for supporting creation by using user-based metadata, the system comprising:
a user terminal configured to receive evaluation data on video content from a user who watched the video content;
a utilizer terminal configured to receive a search value from a utilizer desiring a search and request a video content search; and
a service providing server configured to receive the evaluation data from the user terminal, construct metadata of video content, and compare the search value received from the utilizer server with the metadata for searching for a corresponding video content,
wherein the metadata comprise:
basic information comprising content basic information storing objective information on overall video content and sector basic information storing subjective information on a particular scene; and
evaluation information comprising content evaluation information storing user evaluations on overall video content and sector evaluation information storing user evaluations on a particular scene,
wherein the search value comprises:
a basic search value for the objective information on the video content;
an evaluation search value for searching for subjective evaluations on the video content; and
an analysis reference value as a criterion for statistical analysis on a search result,
wherein the service providing server comprises:
a database configured to store multiple pieces of video content comprising the metadata; and
a search engine configured to compare the search value received from the utilizer server with the metadata stored in the database for searching for video content and a scene corresponding thereto,
wherein the search engine produces an analysis result according to the analysis reference value inputted by the utilizer.

3. An information providing method of a creation supporting system using user-based metadata, the method comprising the steps of
(A) receiving a search reference item from a service providing server through a utilizer terminal;
(B) receiving a search value from a utilizer through the utilizer terminal and transferring the search value to the service providing server;
(C) classifying the search value into a basic search value and an evaluation search value, comparing the basic search value with content basic information and sector basic information of metadata, and comparing the evaluation search value with content evaluation information and sector evaluation information of the metadata for searching for corresponding video content and a corresponding scene by using the service providing server;
(D) producing an analysis result by arranging search results according to the basic search value; and
(E) transferring the analysis result to the utilizer terminal,
wherein, in the step (D),
sectors corresponding to the evaluation information of particular content are arranged in time series of the particular content to thereby produce the analysis result in the case that the basic search value indicates the particular content; and
cumulative frequencies of sectors corresponding to the evaluation information of each content belonging to a particular genre are arranged in time series of the each content to thereby produce the analysis result in the case that the basic search value indicates the particular genre.

4. An information providing method of a creation supporting system using user-based metadata, the method comprising the steps of:
(a) receiving a search reference item from a service providing server through a utilizer terminal;
(b) receiving a search value from a utilizer through the utilizer terminal and transferring the search value to the service providing server;
(c) classifying the search value into a basic search value and an evaluation search value, comparing the basic search value with content basic information and sector basic information of metadata, and comparing the evaluation search value with content evaluation information and sector evaluation information of the metadata for searching for corresponding video content and a corresponding scene by using the service providing server;
(d) producing an analysis result by arranging search results according to an analysis reference value included in the search value; and
(e) transferring the analysis result to the utilizer terminal,
wherein, the search value comprises:
a basic search value for the objective information on the video content;
an evaluation search value for searching for subjective evaluations on the video content; and
an analysis reference value as a criterion for statistical analysis on a search result.
